(19) United States
(12) Patent Application Publication
(10) Pub. No.: US 2024/0309210 A1
(43) Pub. Date: Sep. 19, 2024

(54) METHOD AND DEVICE FOR PRODUCING PRODUCTS BY USING LIGNOCELLULOSE-CONTAINING PARTICLES

(71) Applicant: POLYMERTREND LLC., Orchard Park, NY (US)

(72) Inventors: Max ZAHER, Stade (DE); Wolfgang SCHWARZ, Stade (DE); Volker THOLE, Eberswalde (DE)

(73) Assignee: POLYMERTREND LLC., Orchard Park, NY (US)

(21) Appl. No.: 18/670,534

(22) Filed: May 21, 2024

Related U.S. Application Data
(62) Division of application No. 17/276,884, filed on Mar. 17, 2021, now abandoned.

(30) Foreign Application Priority Data
Sep. 18, 2018 (EP) 18195207.8

(51) Int. Cl. C08L 97/02; B27K 5/00; B27N 1/02; B27N 3/02

(52) U.S. Cl. CPC C08L 97/02; B27K 5/0035; B27N 1/02; B27N 3/02; C08L 2205/03; C08L 2205/14

(57) ABSTRACT

The invention relates to a method and devices for producing products (65) by using cellulose-containing particles, with which the following steps are carried out: a) irradiating the particles with electrons in the energy range >1 MeV: b) mixing the irradiated particles with electron-beam-reactive powder of a synthetic polymer, in particular a thermoplastic, having powder particle sizes <2000 micrometres and/or with a liquid electron-beam-reactive synthetic or bio-based polymer; c) forming the mixture created in a way corresponding to the form of the product to be produced, in particular forming it into a nonwoven (56): d) heating the formed mixture to 100-180° C.; e) pressing the formed mixture without heating; and f) irradiating the pressed mixture with electrons in the energy range of 1 MeV to 10 Me V and also with appropriately chosen dosages and dosing rates.

### CROSS-REFERENCE TO RELATED APPLICATIONS

This application is a Divisional of copending application Ser. No. 17/276,884, filed on Mar. 17, 2021, which is the National Phase under 35 U.S.C. § 371 of International Application No. PCT/EP2019/074883, filed on Sep. 17, 2019, which claims the benefit under 35 U.S.C. § 119(a) to patent application Ser. No. 18/195,207.8, filed in Europe on Sep. 18, 2018, all of which are hereby expressly incorporated by reference into the present application.

The invention relates to methods and devices for producing products by using lignocellulose-containing particles. In particular, the invention relates to a method for producing a mixture of lignocellulose-containing particles with electron-beam-reactive synthetic polymers in powder form and/or electron-beam-reactive synthetic and/or bio-based, partly synthetic polymer liquids, a method for producing a lignocellulose-containing moulded part, a device for pretreating lignocellulose-containing particles suitable for mixing with electron-beam-reactive powder of a polymer and/or a liquid containing an electron-beam-reactive polymer and a device for producing a composite by using lignocellulose-containing particles.

Substances made of wood or of non-woody plants or also a mixture of these, e.g. in the form of chips, fibres, so-called strands or flakes, can be considered in particular here as lignocellulose-containing particles. Said particles thus comprise in particular woody and ligneous chips and fibres.

Native cellulose-containing raw materials in particular, such as wood of diverse tree species and provenance (fresh, old or recycled), for example, should be understood here as wood chips or wood fibres and ligneous chips or fibres.

Other examples of ligneous chips or fibres in the sense of this description are bamboo, straw from maize or cereals, and fibre plants such as flax or jute.

The use of ionising radiation for treating and in particular pulping native cellulose-containing raw materials for various further processing purposes is known as such. Examples are pest decontamination, the facilitation of so-called refining or fibre pulping in paper manufacturing or also the acceleration of saccharification and fermentation, e.g. in the production of bioethanol.

In particular, the invention relates to the production of chipboard and MDF/HDF sheets.

In the prior art it is known to use a chopper for chopping ligneous raw materials, a chipper for producing chips, a screen for determining the chip or fibre sizes, a washing installation, a so-called defibrator (in MDF production), a dryer, a mixer for mixing the chips or fibres with a binder, in particular the component formaldehyde, a system for producing nonwovens, a pre-press and a full press with heating to e.g. 220° C. as well as means for post-treating the chipboard or MDF/HDF sheets. The use of formaldehyde is problematic in this case with regard to health protection and fire risk.

US 2011/060133 A1 describes irradiation of wood/plastic mixtures using electrons in the MeV range.

The prior art is to be improved in particular with reference to the following properties and parameters:
Productivity in production, energy expenditure, required temperatures, mixing and setting times, cooling times, thickness swelling, abrasion and bending resistance (modulus of elasticity), transverse tensile strength, ease of further processing, UV protection, resistance to temperature change and moisture, bioresistance of products to spores, fungi, insects, fire safety, health protection etc.

The object of the invention is to provide methods and devices with which some of the aforesaid aims can be achieved, at least in part, when processing ligneous chips and fibres into wood composites.

The invention first relates to a method and a device for producing an intermediate product in the manufacture of wood composites, namely the production of wood or ligneous chips or fibres suitable for mixing with an electron-beam-reactive powder of a synthetic polymer and/or for mixing with a liquid electron-beam-reactive synthetic or bio-based polymer.

To this end the invention teaches irradiation of the chips or fibres using high-energy electrons in a required dosage, preferably under normal pressure in air.

A realisation underlying the invention is that using such irradiation, the chips or fibres are prepared particularly well to be mixed with a thermoplastic in the production of a wood composite such as chipboard or MDF/HDF sheets. Irradiation with electrons in the dosage range from 50 to 150 kGy in air has proved particularly suitable.

Such an energy input results in the splitting of fibre bundles, to bond dissociations on and between molecule chains with the formation of new groups containing oxygen, to the separation of low-molecular fragments and to new molecule linkages between the different wood constituents (cellulose, hemicelluloses, lignin). As a consequence of the simultaneous effect of ozone on the enlarged and more hydrophilic fibre surfaces, easier adhesion of added special polymers in powder or liquid form can take place hereby. Their selection is directed towards particularly easy fragmentation during subsequent electron irradiation and the formation of new, preferably three-dimensional linkages and stable networks (crosslinking). The acceleration energy of the electrons (in MeV) is the decisive parameter in this case for their penetration depth into the bulk material to be irradiated or into a solid. The penetration depth is inversely proportional to the density of the material to be irradiated in each case, but the electrons are subject to increasing deceleration in this way. The higher the acceleration energy, the more product quantity or solid thickness can be captured and permeated. If a material density of 1/cm³ is taken as a basis for ligneous materials, for example, the effective penetration depth at 1 MeV acceleration energy is approximately 2.8 mm, with double-sided irradiation around 7 mm. At 10 MeV a thickness of 32 mm is captured, and in double-sided irradiation around 80 mm of thickness as a result of crossing residual electron currents.

The quantity of electrons produced, the beam current (unit of measurement in milliamperes, mA), is the source for the radiation dosage: it characterises the amount of energy in kGy that the electrons emit in the course of their penetration path and their deceleration at the target material concerned, it reduces increasingly with advancing depth. Ultimately it falls below a threshold of chemical inefficacy or desired process relevance. In particular, it is important to optimise the radiation dosage towards the product aim: the reaction sensitivity of the radiation-crosslinking polymers and their mixtures selected as binding agents for the wood, their crosslinking behaviour with one another and the resulting product quality are important. The dosage input per time, the dosing rate, depends on the efficiency of the electron emitter, the dosing rate has an influence on the chemical reaction, but it is basically noteworthy from an economic perspective.

Electron emitters as such are well known in the prior art and have long been present in countless market applications. A distinction is drawn between low-energy emitters up to approx. 300 keV, then medium, and high-energy emitters above approx. 3-5 MeV, depending on the application area. They are used accordingly (in the case of thin layers) e.g. for surface sterilisation or paint curing, in deeper material treatment (with MeV) likewise for sterilisation/decontamination (packets), for reducing pollutants in waste water, degradation of plant raw materials e.g. for bioethanol production or for polymer crosslinking such as e.g. of composites (WPC), car tyres or polyethylene pipes.

The construction principle consists of a hot cathode, from which electrons are emitted in a high vacuum and are accelerated via a high-voltage potential cascade towards the anode focused as a beam. The beam is mostly pulsed and can deliver several hundred milliwatts per pulse. Due to electromagnetic diversion at the highest possible frequencies, the beam is scanned in a beam funnel for the operating widths aimed for and enters the process chamber through an electron exit window of mostly titanium foil to exert its effect in an atmosphere at normal pressure. High-energy emitters in particular necessitate extensive protection from the X-radiation generated at the same time; i.e., separate thick-walled buildings with import and export transport routes with multiple angles for the goods to be irradiated.

The ozone gas arising during electron radiation in air, which is highly corrosive and has an effect that is detrimental to health, likewise necessitates protective measures.

For efficient industrial technical applications, where the emitters must produce powerful beam currents (dosage, dosing rate) and great penetration depths (MeV) into the targets, different implementations exist. The designs offered require power inputs of up to several hundred kilowatts; they deliver acceleration energies (MeV) and beam currents as required.

Linear accelerators (LINACs) with up to 10 MeV, Rhodotrons (7 MeV/700 KW and 10 MeV/200 kW) or Dynamitrons with 5 MeV/300 kW are on the market. Wood or ligneous chips and fibres prepared thus using electron radiation are used for a method for producing a wood composite.

The method includes at least the following steps:
a) Irradiation of wood or ligneous chips or fibres in air with electrons in the energy range >1 MeV;
b) Mixing the pretreated irradiated chips or fibres with an electron-beam-reactive synthetic polymer powder, in particular a thermoplastic, with powder particle sizes <2000 micrometres (μm) and/or with a liquid electron-beam-reactive synthetic or bio-based polymer;
c) Forming the mixture produced in a way corresponding to the form of the wood composite to be produced, in particular forming it into a nonwoven;
d) Heating the formed mixture to 100-180° C.;
e) Pressing the formed mixture without significant heating; and
f) Irradiating the pressed mixture with electrons in the energy range from 1 MeV to 10 MeV.

A plurality of chemical compounds in liquid or solid form are known and can be used as “electron-beam-reactive” in the sense of the method for the mixture with the irradiated chips or fibres for the purpose of producing a composite product. A common feature are chemical bonds that are easily fissionable by means of electron beams by way of mostly radical reaction mechanisms and the striving of the fragments for preferred two-and three-dimensional reunification (polymerisation, crosslinking to form 3D networks). Typical polymer types for this are low-density polyethylene of medium molecular weights (linear chains without double bonds, LDPE), for example, as well as polyvinyl chloride (PVC) or ethylene vinyl acetate copolymers (EVA). Acrylates or vinyls, mostly in liquid form, constitute suitable compound groups with highly reactive chemical double bonds.

These can be combined in turn with a plurality of chemical partners such as epoxy acrylates, for example, or reactive organic silicon compounds. Furthermore, there is a plurality of bio-based products and natural substances such as e.g. virgin or prepared (bio-based) oils, which have double bonds in particular and likewise tend to polymerise and/or crosslink due to initiation using electron beams.

If required, small additional quantities such as of e.g. bonding enhancers on the base material (wood finishes), fire retardants, electrical conductivity agents, hydrophobic additives and/or UV stabilisers are used to improve the quality of the end product.

It has been shown that for the admixture of a powdered synthetic polymer, in particular thermoplastic, powder particle sizes smaller than 2000 micrometres (μm) are suitable, in particular particle sizes in the range of 1000 to 1500 micrometres.

One advantage of the invention lies in the fact that the phenol or urea resins with health-endangering formaldehyde that are typically used in the prior art can be dispensed with.

Another advantage of the invention in respect of energy outlay and productivity is that in the production of the wood composite according to feature 3e), the pressing can take place without significant heating, in particular cold.

The subsequent irradiation of the pressed mixture by electrons takes place in the electron energy range from 1 to 10 MeV, preferably powerfully in the energy range from 5 to 10 MeV to crosslink the polymer in corresponding layer quantities. The dosage range here is preferably 50 to 150 kGy. The parameters with regard to energy, dosage and dosing rate should be optimised experimentally for the given system; thus depending on e.g. the type of wood, the preparation of the chips and fibres, the moisture content, the type of polymer that can be crosslinked by electron beam reaction, the mixing ratio of polymer-wood and of the types of polymer used in relation to one another, parameters of the previous pressing, residual temperature and the specific product aim and its product quality.

The invention also relates to a wood composite produced by the method according to the invention, in particular a chipboard or an MDF/HDF sheet (MDF: medium-density fibreboard; HDF: high-density fibreboard). Other wood composites in the sense of the invention are so-called OSB (oriented strand board) and the composite WPC (wood-plastic composite).

The pressed board can optionally be post-formed three-dimensionally before final irradiation by electrons.

The invention also includes devices according to claims 12 to 15.

Exemplary embodiments of the invention are described below in greater detail with reference to the figures.

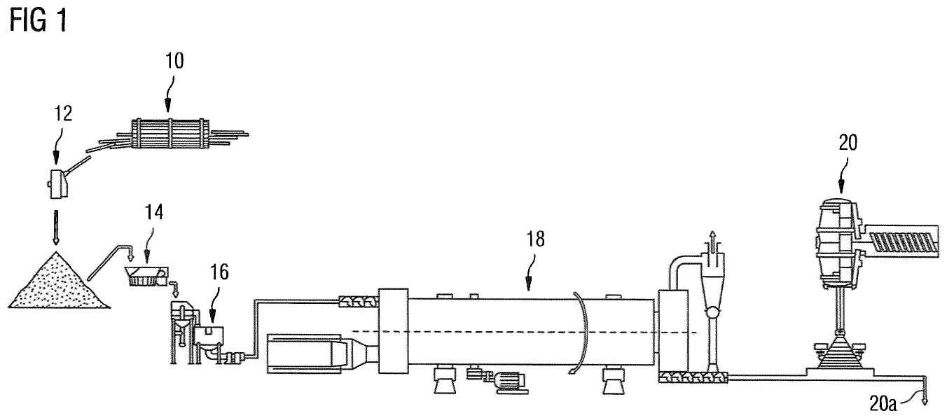

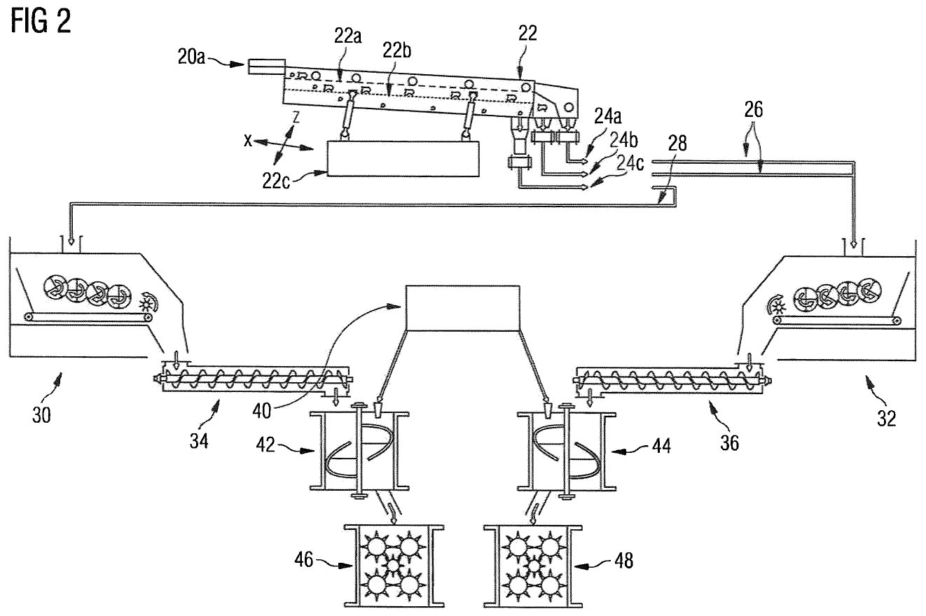

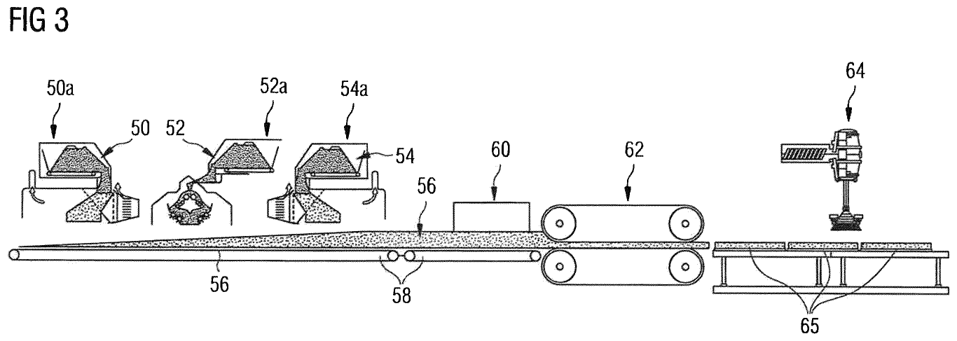

FIGS. 1 to 3 explain a method and a device for producing chipboard.

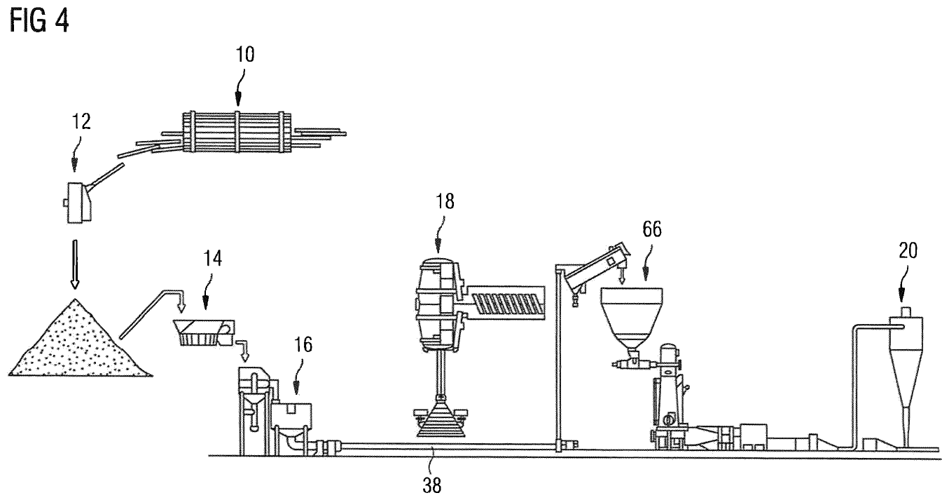

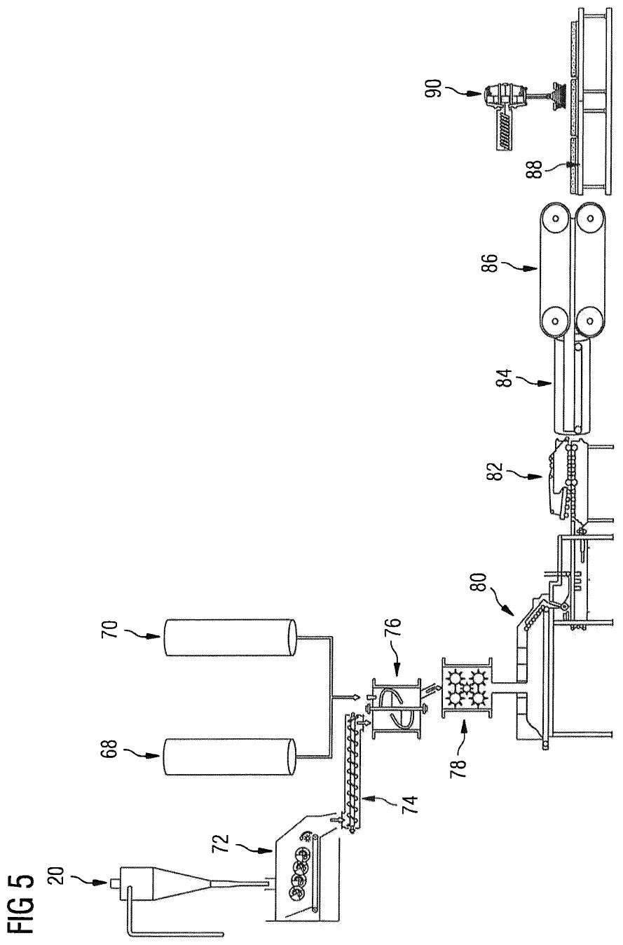

FIGS. 4 and 5 explain a method and a device for producing MDF/HDF sheets.

Two exemplary embodiments of the invention are described in greater detail below, namely the production of wood composites in the form of chipboard and in the form of MDF/HDF sheets.

FIGS. 1 to 3 each show a section of the method or of the device in a temporal-spatial sequence.

A chopper (10) chops raw wood. A chipper (12) then processes the chopped wood into chips. These are washed in a washer (16), then screened, and dried if required.

A minimal moisture level can be retained in this case to promote the effect of the subsequent electron irradiation. When crushing recycled or used wood, an additional device (magnet) is used to remove metal foreign bodies.

Small quantities of additives, e.g. for hydrophobisation or flame retardancy, can be added if necessary.

The irradiated chips are then supplied to a dryer (18). The dryer as such has a conventional design.

Thus prepared, the chips are then irradiated in an electron beam accelerator (20) using acceleration energies in the range between 5 and 10 MeV; with suitably selected parameters in each case with regard to the initial raw material and the operational throughput (bulk quantity and bulk density). The dosage is optimised in the range from 50 to 150 kGy according to the treatment parameters determined as necessary for the subsequent preparation of the desired wood composite mixture.

Dryers and electron beam accelerators can be interchanged. Irradiation can thus take place before and/or after drying. This depends on the moisture content of the chips. Irradiation is more effective if the chips contain roughly 10-20% moisture.

The output (20a) of the electron beam accelerator (20) is connected to a screening repository (22) and the dried chips are split into 3 size-dependent fractions via screens (22a, 22b), which are shaken in the horizontal plane via a drive. A coarse fraction is discharged via an outlet (24a), a medium fraction via an outlet (24b) and a small fraction via an outlet (24c).

A conveyor (26) carries the coarse and medium fractions to a chip dosing unit (32), while the fine fraction passes via a conveyor (28) to a chip dosing unit (30). From these dosing units the respective chips enter a hot screw conveyor (34 and 36). From these screw conveyors (34 and 36) the respective fractions (fine, medium and coarse) enter the correspondingly assigned mixer (42) for fine chips and mixer (44) for medium and coarse chips.

From a dosing unit (40) thermoplastic powder particles with particle sizes in the range between 1000 and 1500 μm enter the mixers (42, 44), where chips and thermoplastic powder are mixed.

Binding agents such as paraffin or starch can be added in the dosing unit or in the mixer.

The fine chip/thermoplastic powder mixture is transferred from the mixer (42) to a deagglomerator (loosener) (46), the medium/coarse chip mixture is transferred from the mixer (44) to a deagglomerator (48).

To produce a nonwoven, the mixture is conveyed from the deagglomerator (46) (fine fraction) both to a bottom-layer spreader (50) via its inlet (50a) and to a top-layer spreader (54) via its inlet (54a). The outlet of the other deagglomerator (48) is connected to the inlet (52a) of a middle-layer spreader (52).

The bottom-layer spreader, middle-layer spreader and top-layer spreader are controlled timewise and spatially such that a nonwoven is formed among them with a bottom layer (fine chip), a middle layer (medium and coarse chip) above this and a top layer (fine chip).

The nonwoven (56) passes via a conveyor (58) to a preheating facility (60). The heating temperatures depend on the given system. For example, the heating can take place via HF (high frequency), IR (infrared) or MW (microwave).

The nonwoven is then supplied to a press (62), which is a cooling press in the exemplary embodiment depicted and thus (in contrast to the prior art) does not require any energy-and time-consuming heating. In the press (62), the nonwoven is formed into sheets (65) and then cut to size. (Further forming can optionally take place into three-dimensional constructional products.) The sheets formed by pressing (products) (65) are then transferred via special transport passages necessitated by X-ray protection to the process chamber of an electron beam accelerator (64) and irradiated there using high-energy electrons in the energy range from 1 to 10 MeV and with a suitably selected dosage or dosing rate in air to carry out crosslinking within the reactive synthetic or partly synthetic polymer mixture (in particular thermoplastic powder and/or liquid polymers) as well as to bring about adhesion or also chemical combination of same with the crushed and pretreated wood raw material and its constituents (cellulose, lignin) etc.

The result of this production technology is a chipboard (or specially formed product) with very good properties, in particular in respect of temperature change resistance, hydrophobia, dimensional stability, bending resistance, transverse tensile strength, health protection and recyclability.

The method is advantageous in particular in respect of energy saving (low heating requirement), productivity (low time outlay) and environmental compatibility etc.

A method and a device for the production of MDF/HDF sheets and WPC wood composites will now be described in greater detail with reference to FIGS. 4 and 5.

In the figures, the same reference characters relate to components corresponding to one another.

Chopper (10), chipper (12), screening plant (14), washer (16) and electron emitter (18) correspond substantially to the exemplary embodiment according to FIG. 1, the process parameters (chipper 12) now being set so that wood fibres or fibres of ligneous material for MDF/HDF sheets or WPC wood composites are produced.

The electron-irradiated fibres are supplied via a conveyor (38) to a so-called defibrator (fibre loosener) (66) (known as such in the prior art), from where the fibres enter a dryer (20).

According to FIG. 5, the dried fibres are transferred from the dryer 20 to a fibre spreader (72), where they are loosened further and supplied in a metered manner to a screw conveyor (74), which is preferably heated. From there the fibres pass into a mixer (76).

Connected to the mixer (76) are on the one hand a dosing unit (68) with an electron-beam-reactive synthetic or bio-based polymer liquid and on the other hand a dosing unit (70) with a thermoplastic powder mixture as a common binding agent mixture for the wood chips.

Depending on the desired properties of the MDF/HDF sheet to be produced, the control system permits a supply of liquid and/or powder to the mixer (76).

If only powder is supplied to produce an MDF sheet, for example, this can take place with 10 to 20% related to the total mass.

On the other hand, the powder proportion can be measured at 30 to 35% for a WPC composite. (WPC: Wood-Polymer Composites)

From the mixer (76) the mixture enters a deagglomerator (78), which can be cooled. From the deagglomerator (78) the mixture passes into a fibre spreader (80), which forms (in a known manner) the nonwoven, which is prepared for the pressing process in another nonwoven forming station (82).

A preheater (84), e.g. HF/MW, heats the nonwoven, which is then pressed in a press (86). Pressing is carried out preferably without heating (cool). The sheets are then cut to size, (optionally post-formed into special products) and irradiated in an electron beam accelerator (90) by electrons, approximately in the energy and dosage range indicated above, for the purpose of crosslinking the electron-beam-reactive polymer mixtures including linkage to the wood constituents or their surfaces.

The MDF/HDF sheets or WPC composites thus produced have similar advantages to the chipboard described above.

### Reference character list

10 Chopper
12 Chipper
14 Screening plant
16 Washer
18 Dryer
20 Electron beam accelerator
20a Exit (from 20)
22 Screening plant
22a Screen, coarse
22b Screen, fine
22c Drive
24a Chip outlet (coarse)
24b Chip outlet (medium)
24c Chip outlet (fine)
26 Conveyor (for 24a, 24b)
28 Conveyor (for 24c)
30 Chip dosing unit
32 Chip dosing unit
34 Screw conveyor (hot)
36 Screw conveyor (hot)
38 Conveyor
40 Dosing unit
42 Mixer
44 Mixer
46 Deagglomerator (especially cooled)
50 Bottom-layer spreader
50a Inlet to 50 from 46
52 Middle-layer spreader
52a Inlet to 52 from 48
54 Top-layer spreader
54a Inlet to 54 from 46
56 Nonwoven
58 Conveyor
60 Preheater (HF/IR/MW)
62 Press
64 Electron emitter (electron beam accelerator)
65 Boards
66 Defibrator/pulper
68 Dosing unit for liquid
70 Dosing unit for powder
72 Fibre spreader
74 Heating screw conveyor
76 Mixer
78 Deagglomerator
80 Fibre spreader
10 82 Nonwoven formation
84 Preheater (HF/MW)
86 Cooling press
88 Conveyor
90 Electron beam accelerator

1. Method for producing a formed part containing lignocellulose, the method having the following steps:
a) irradiation of lignocellulose-containing particles in the energy range between 1 MeV and 10 MeV, preferably >3 MeV<8 MeV;
b) mixing the irradiated lignocellulose-containing particles with an electron-beam-reactive polymer in powder form, in particular a thermoplastic, with powder particle sizes <2000 micrometres (μm), and/or with a liquid containing electron-beam-reactive polymer;
c) forming of the mixture produced in a way corresponding to the form of the formed part to be produced, in particular forming it into a nonwoven;
d) conveying the formed mixture to a preheating device;
e) heating the formed mixture to 100-180° C.;
f) pressing the formed mixture without significant heating; and
g) irradiating the pressed mixture with electrons in the energy range from 1 MeV to 10 MeV.

2. Method according to claim 1, characterised in that in step a) irradiation takes place with a dosage between 50 and 150 kGy, in particular with a dosage input of 100 kGy plus/minus 20 kGy.

3. Method according to claim 1, characterised in that in step f) irradiation takes place according to the specified mixture recipe and selected product aim with a dosage from 50 to 250 kGy, in particular 100 kGy plus/minus 20 kGy.

4. Method according to claim 1, characterised in that in step e) a nonwoven is pressed to form a board.

5. Method according to claim 1, characterised in that in step b) the particle sizes are in the range from 1000 to 1500 micrometres (μm).

6. Method according to claim 1, characterised in that in step b) to produce a wood material, 5% to <30% proportions by mass of a polymer are added.

7. Method according to claim 1, characterised in that in step b) to produce a WPC 30% to 60% proportions by mass of a polymer are added.

8. Method according to claim 1, characterised in that in step a) the energy range is between 5 and 10 MeV.

9. Method according to claim 1, characterised in that in step b) the lignocellulose-containing particles are heated before or during the addition of the thermoplastic powder to a temperature from 60° C. to 160° C., preferably to 80° C. to 120° C.

10. Method according to claim 1, characterised in that before or in step b) the lignocellulose-containing particles are acted upon by an adhesive agent before the addition of the thermoplastic powder.

11. Method according to claim 10, characterised in that adhesives and/or paraffins, starches and/or albuminous substances are used as adhesive agents.

12. Device for producing a composite containing lignocellulose-containing particles, said device comprising:
a) an first electron beam accelerator designed to irradiate the particles with electrons in the energy range >1 MeV;
aa) a screening repository designed to split the particles into three size-dependent fractions via screens into a coarse fraction, a medium fraction, and a fine fraction;
ab) a bottom layer spreader and a top layer spreader designed to form a bottom layer and a top layer from the particles of said fraction;
ac) a middle layer spreader designed to form a middle layer from the particles of said coarse fraction and said medium fraction;
b) at least one mixer designed to mix the irradiated particles with electron-beam-reactive powder of a synthetic polymer, with powder particle sizes <2000 micrometres (μm), and/or with a fluid containing electron-beam-reactive synthetic polymer;
c) a device designed to form the mixture produced in b) in a way corresponding to the form of the composite to be produced;
d) a conveyor for conveying the formed mixture to a preheating device;
wherein said the preheating device is a high frequency heater (HF), an infared heater (IR) or a microwave heater (MW) designed to heat the formed mixture to 100° C. to 180° C.;
e) a press designed to press said formed mixture without significant heating; and
f) a high-energy electron beam accelerator in the energy range from 1 MeV to 10 MeV in an outwardly radiation-protected process chamber to irradiate the pressed and formed mixture carried past by a transport device.

13. Method according to claim 2, characterised in that in step f) irradiation takes place according to the specified mixture recipe and selected product aim with a dosage from 50 to 250 kGy.

14. Method according to claim 2, characterised in that in step e) a nonwoven is pressed to form a board.

15. Method according to claim 3, characterised in that in step e) a nonwoven is pressed to form a board.

16. Method according to claim 2, characterised in that in step b) the particle sizes are in the range from 1000 to 1500 micrometres (μm).

17. Method according to claim 3, characterised in that in step b) the particle sizes are in the range from 1000 to 1500 micrometres (μm).
